(19) United States
(12) Patent Application Publication
(10) Pub. No.: US 2026/0116099 A1
(43) Pub. Date: Apr. 30, 2026

(54) PRINTER

(71) Applicant: Roland DG Corporation, Hamamatsu-shi (JP)

(72) Inventors: Ryosuke NONAKA, Hamamatsu-shi (JP); Takayuki MORIKAMI, Hamamatsu-shi (JP)

(21) Appl. No.: 19/374,425

(22) Filed: Oct. 30, 2025

(30) Foreign Application Priority Data
Oct. 31, 2024 (JP) 2024-191656

(51) Int. Cl. B41J 11/66; B41J 11/06; B41J 15/04

(52) U.S. Cl. CPC B41J 11/663; B41J 11/06; B41J 15/046

(57) ABSTRACT

A printer includes a support plane to support a medium, a restrictor to hold, together with the support plane, an end in a second direction of the medium supported by the support plane, a cutter to cut the medium supported by the support plane, and a controller configured or programmed to include a cutout formation controller configured or programmed to perform control such that a plurality of cutouts extending in the second direction are formed in the medium. An end margin is provided in a portion of the medium between the end of the medium and the cutout closest to the end of the medium. Where a region of the medium overlapping the restrictor is an overlapping region, a length in the second direction of the end margin is longer than a length in the second direction from an end of the medium to an innermost position of the overlapping region of the medium.

### CROSS REFERENCE TO RELATED APPLICATION

This application claims the benefit of priority to Japanese Patent Application No. 2024-191656 filed on Oct. 31, 2024. The entire contents of this application are hereby incorporated by reference herein.

### BACKGROUND OF THE INVENTION

### 1. Field of the Invention

The present invention relates to printers.

### 2. Description of the Related Art

For example, Japanese Laid-Open Patent Publication No. 2023-114964 discloses a printer including a platen supporting a medium, a media clamp pressing a left end and a right end of the medium, and a sheet-cutting cutter performing sheet cutting on the medium. The medium supported by the platen is transported in a transportation direction.

In the above-described printer, while the medium supported by the platen is being transported in the transportation direction, the medium enters a gap between the media clamp and the platen. This makes it difficult for the left end and the right end of the medium to rise. In addition, the medium supported by the platen is subjected to sheet cutting performed by the cutter and thus is divided into two.

When the above-described printer is to perform sheet cutting, so-called perforations may be formed in the medium. The perforations are, for example, a plurality of cutouts aligned in a predetermined direction. If the cutouts are formed at the left and right ends of the medium, portions of the medium around the cutouts may easily rise and ride on the media clamp. This may prevent the medium from being pressed by the media clamp. As a result, an undesirable situation may occur where the portions of the medium that are not pressed by the media clamp contact an ink head, which is located above the platen. It is desirable that even in a state where the medium is not pressed by the media clamp, the left and right ends of the medium do not easily rise.

### SUMMARY OF THE INVENTION

Example embodiments of the present invention provide printers in each of which an end of a medium supported by a support table does not easily rise.

A printer according to an example embodiment of the present invention includes a support table including a support plane to support a medium, a medium moving mechanism to move the medium, supported by the support plane, in a first direction, a restrictor provided on the support plane to hold together with the support plane an end in a second direction of the medium supported by the support plane, the second direction crossing the first direction, a cutter to cut the medium supported by the support plane, and a controller configured or programmed to include a cutout formation controller configured or programmed to perform control such that a plurality of cutouts extending in the second direction are formed in the medium supported by the support plane. An end margin is provided in a portion of the medium that is between the end of the medium and one of the plurality of cutouts closest to the end of the medium. Where a region of the medium supported by the support plane that overlaps the restrictor is an overlapping region, the end margin has a length in the second direction that is longer than a length in the second direction from the end of the medium to an innermost position of the overlapping region of the medium.

With the above-described printer, a plurality of the cutouts aligned in the second direction are formed in the medium, such that no cutout is formed at the end in the second direction of the medium. No cutout is formed at the end in second direction of the medium, and therefore, the end in second direction of the medium is made difficult to rise. In addition, while the medium supported by the support plane is being moved in the first direction, the end margin with no cutout is allowed to enter a gap between the restrictor and the support plane. Therefore, while the medium is being moved in the first direction, the portion including the cutouts formed in the medium is not easily stuck with the restrictor or does not easily ride on the restrictor.

Another printer according to an example embodiment of the present invention includes a support table including a support plane to support a medium, a medium moving mechanism to move the medium, supported by the support plane, in a first direction, a restrictor provided on the support plane to hold together with the support plane an end in a second direction of the medium supported by the support plane, the second direction crossing the first direction, a cutter to cut the medium supported by the support plane, a sensor to detect whether or not the restrictor is provided on the support plane, and a controller configured or programmed to include a cutout formation controller configured or programmed to perform control such that a cutout extending in the second direction is formed in the medium supported by the support plane, and a restrictor determinator to determine whether or not the restrictor is provided on the support plane. A region of the medium supported by the support plane that overlaps the restrictor is defined as an overlapping region. When the restrictor determinator determines that the restrictor is provided on the support plane, the cutout formation controller is configured or programmed to perform control such that the cutout is formed from a first separation position that is inward, in the second direction, relative to an inner end in the second direction of the restrictor and is spaced away from the inner end by a predetermined first distance. When the restrictor determinator determines that the restrictor is not provided on the support plane, the cutout formation controller is configured or programmed to perform control such that the cutout is formed from a second separation position that is inward, in the second direction, relative to an inner end in the second direction of the overlapping region of the medium and is spaced away from the inner end by a predetermined second distance shorter than the first distance.

Example embodiments of the present invention provide printers in each of which an end of a medium supported by a support table does not easily rise.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a front view a printer according to example embodiment 1 of the present invention.

FIG. 2 is a cross-sectional view of the printer taken along line II-II in FIG. 1.

FIG. 3 is a bottom view schematically showing configurations of bottom surfaces of a carriage and ink heads.

FIG. 4 is a block diagram of the printer according to example embodiment 1 of the present invention.

FIG. 5 is a plan view showing a configuration of a support plane.

FIG. 6 is a plan view showing a restrictor and cutouts formed in a medium.

FIG. 7 is a plan view showing cutouts formed in a medium in the case where a restrictor is provided on the support plane in example embodiment 2 of the present invention.

FIG. 8 is a front view showing a carriage and a sensor in example embodiment 2 of the present invention.

FIG. 9 is a block diagram of a printer in example embodiment 2 of the present invention.

FIG. 10 is a plan view showing cutouts formed in the medium in the case where the restrictor is not provided on the support plane in example embodiment 2 of the present invention.

### DETAILED DESCRIPTION OF THE EXAMPLE EMBODIMENTS

Hereinafter, printers according to example embodiments of the present invention will be described with reference to the drawings. Example embodiments described herein are not intended to limit the present invention. Components and portions having the same functions will bear the same reference signs, and overlapping descriptions will be omitted or simplified when appropriate.

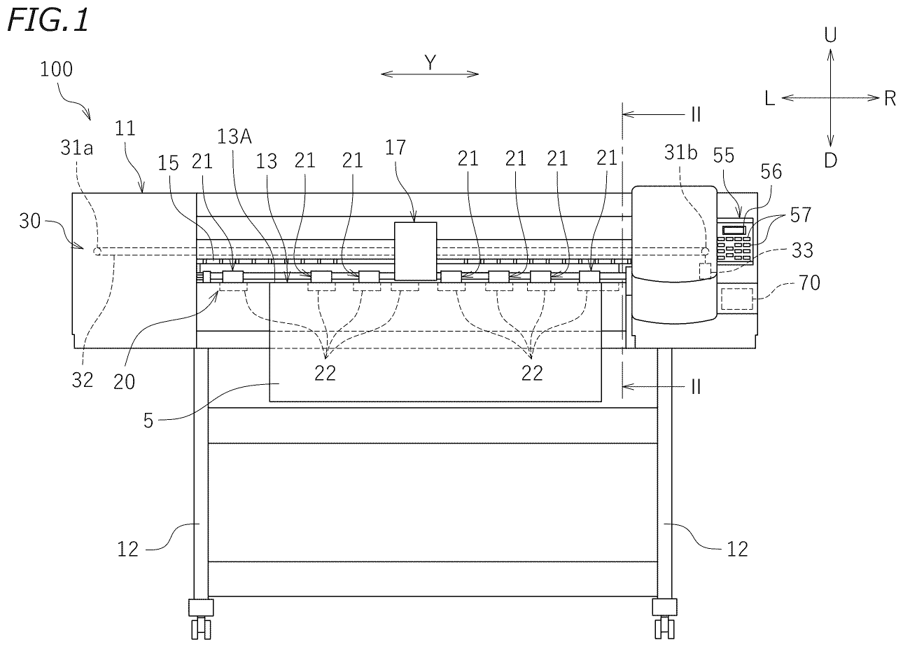

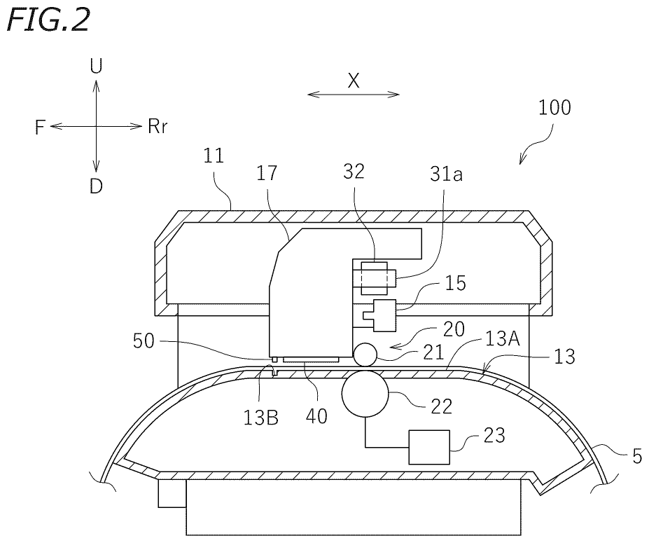

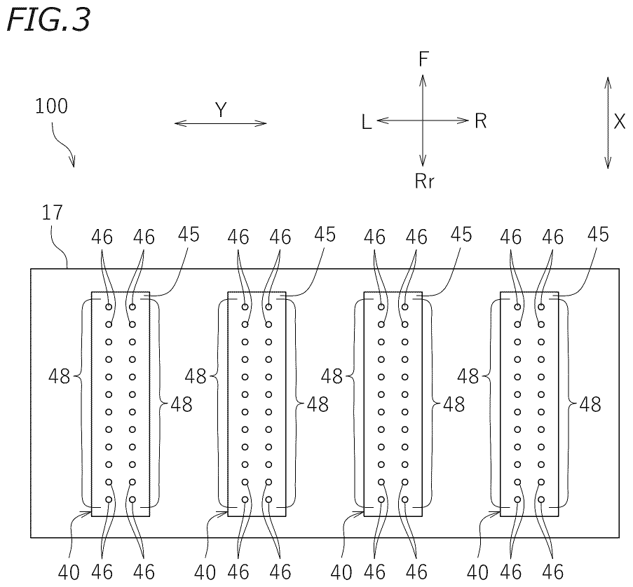

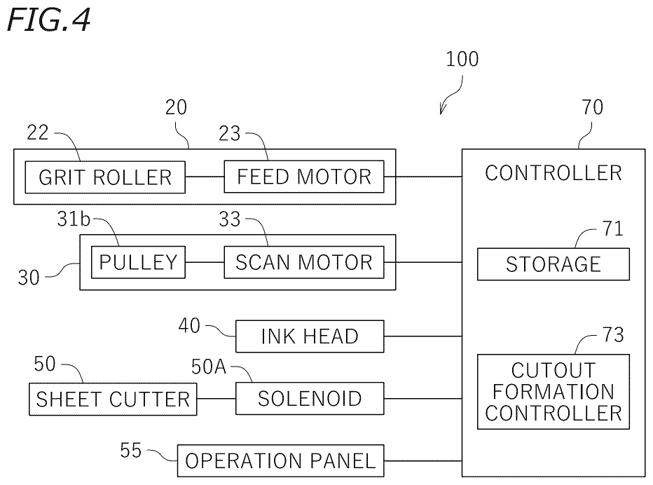

Hereinafter, a printer 100 according to example embodiment 1 will be described. FIG. 1 is a front view of the printer 100 according to this example embodiment. FIG. 2 is a cross-sectional view of the printer 100 taken along line II-II in FIG. 1. FIG. 3 is a bottom view schematically showing configurations of bottom surfaces of a carriage 17 and ink heads 40 of the printer 100. FIG. 4 is a block diagram of the printer 100 according to this example embodiment. In the following description, terms “left”, “right”, “up” and “down” of the printer 100 will respectively refer to left, right, up and down as seen from a user facing a front surface of the printer 100. A direction from the printer 100 toward the user will be referred to as “forward”, and a direction from the user toward the printer 100 will be referred to as “rearward”. In the drawings, letters F, Rr, L, R, U and D respectively represent front, rear, left, right, up and down for the printer 100. In the drawings, letter Y represents a main scanning direction. In this example embodiment, the main scanning direction Y is a left-right direction. In the drawings, letter X represents a sub scanning direction. In this example embodiment, the sub scanning direction X is a front-rear direction, and crosses (in this example embodiment, perpendicularly crosses) the main scanning direction Y as seen in a plan view. In this example embodiment, the sub scanning direction X is an example of first direction. The main scanning direction Y is an example of second direction crossing the first direction. Note that these directions are merely defined for the sake of convenience, and does not limit the manner of installation of the printer 100 or does not limit the present invention either.

The printer 100 is a printer of an inkjet system, and is a so-called inkjet printer. Note that the printer 100 is not limited to performing printing by an inkjet system, and may be, for example, a printer of a so-called thermal system or a printer of a laser system. In this example embodiment, the printer 100 is a roll-to-roll printer, which moves a medium 5 in the sub scanning direction X with respect to a support table 13 (see FIG. 2) described below.

The printer 100 is to perform printing on the medium 5 as shown in FIG. 2. The medium 5 is, for example, roll-type recording paper, and is, for example, a so-called paper roll. Note that the medium 5 is not limited to such roll-type recording paper. For example, the medium 5 may be formed of paper such as plain paper, inkjet printing paper or the like, may be a sheet or a film formed of a resin material such as polyvinyl chloride, polyester or the like, or may be formed of a wooden material, a fabric material such as woven cloth, unwoven cloth or the like, or any other material.

As shown in FIG. 1, the printer 100 includes a printer main body 11, the support table 13, a medium moving mechanism 20, a guide rail 15, the carriage 17, the ink heads 40 (see FIG. 3), a sheet cutter 50, a head moving mechanism 30, and a controller 70.

As shown in FIG. 1, the printer main body 11 extends in the main scanning direction Y. The printer main body 11 is supported by legs 12. The legs 12 are provided on a bottom surface of the printer main body 11, and extend downward from the bottom surface of the printer main body 11.

As shown in FIG. 2, the support table 13 supports the medium 5. The support table 13 has a support plane 13A. The support plane 13A acts as a top surface of the support table 13, and supports the medium 5. In this example embodiment, the medium 5 is placed on the support plane 13A. Printing on the medium 5 is performed on the support plane 13A. The support table 13 is a so-called platen.

Referring to FIG. 2, the medium moving mechanism 20 moves the medium 5 in the sub scanning direction X with respect to the ink heads 40 (only one is shown in FIG. 2) and the sheet cutter 50. In this example embodiment, the medium moving mechanism 20 moves the medium 5, supported by the support plane 13A of the support table 13, in the sub scanning direction X. There is no specific limitation on the configuration of the medium moving mechanism 20.

In this example embodiment, the medium moving mechanism 20 includes pinch rollers 21 (only one is shown in FIG. 2), grit rollers 22 (only one is shown in FIG. 2), and a feed motor 23. The pinch rollers 21 are provided above the support table 13 and below the guide rail 15, and press the medium 5 from above. The pinch rollers 21 are located to the rear of the carriage 17 as seen in a plan view. The grit rollers 22 are provided in the support table 13, and each have a cylindrical outer circumstance. The grit rollers 22 are buried in the support table 13 in a state where top surfaces thereof are exposed. The grit rollers 22 face the pinch rollers 21. At least one of the plurality of grit rollers 22 is connected with the feed motor 23. When the feed motor 23 is driven in a state where the medium 5 is held between the pinch rollers 21 and the grit rollers 22, the grit rollers 22 rotate. This moves the medium 5, supported by the support plane 13A of the support table 13, in the sub scanning direction X.

The guide rail 15 is located above the support table 13. The guide rail 15 is located parallel to the support plane 13A of the support table 13, and extends in the main scanning direction Y as shown in FIG. 1. The guide rail 15 is in engagement with the carriage 17. The carriage 17 is provided to be slidable with respect to the carriage 17, and is movable in the main scanning direction Y.

Referring to FIG. 2, the ink heads 40 are to discharge ink. The ink heads 40 are provided on the carriage 17. The ink heads 40 are supported by the carriage 17 such that bottom surfaces thereof are exposed downward. There is no specific limitation on the number of the ink heads 40. In this example embodiment, the number of the ink heads 40 is, for example, four as shown in FIG. 3. The four ink heads 40 are aligned in the main scanning direction Y. The ink heads 40 each include a nozzle plane 45. The nozzle plane 45 acts as a bottom surface of the ink head 40. Each nozzle plane 45 has nozzles 46, through which the ink is discharged, formed therein. A plurality of such nozzles 46 are aligned in the sub scanning direction X. In this example embodiment, a line of the plurality of nozzles 46 is referred to as a “nozzle line 48”. Two nozzle lines 48 are provided for one ink head 40. Note that there is no specific limitation on the number of the nozzle lines 48 for one ink head 40. One nozzle line 48 or three or more nozzle lines 48 may be provided for one ink head 40.

The ink discharged from the ink heads 40 (the nozzles 46 in this example embodiment) is one type of ink among, for example, process color ink and spot color ink. The process color ink includes, for example, cyan ink, magenta ink, yellow ink, black ink, and the like. The spot color ink is ink of a color other than the colors of the process color ink. The spot color ink includes, for example, white ink, clear ink, gloss ink, primer ink, fluorescent ink, metallic ink, orange ink, red ink, violet ink, blue ink, green ink, and the like. In this example embodiment, ink of one color is discharged from one nozzle line 48. There is no specific limitation on the material of the ink. Ink of any of various materials that are conventionally used as the materials of ink for a printer (e.g., an inkjet printer) or the like is usable. The above-described ink may be, for example, solvent-based pigment ink or aqueous pigment ink. Alternatively, the above-described ink may be aqueous dye ink, ultraviolet-curable ink, which is cured when being irradiated with ultraviolet rays, or the like.

Referring to FIG. 2, the sheet cutter 50 is to cut the medium 5 supported by the support plane 13A of the support table 13. In this example embodiment, the sheet cutter 50 is used to cut the medium 5 linearly along the main scanning direction Y. The medium 5 cut by the sheet cutter 50 is divided into two portions, that is, a portion on the upstream side (on the rear side in this example embodiment) in the sub scanning direction X and a portion on the downstream side (on the front side in this example embodiment) in the sub scanning direction X. In the following description, to cut the medium 5 linearly in the main scanning direction Y for the purpose of dividing the medium 5 into two in the sub scanning direction X will be referred to as “sheet cutting”. The sheet cutting may be formation of the so-called perforations in the main scanning direction Y, or may be an operation performed by the user of, after the perforations are formed in the medium 5, cutting the medium 5 to divide the medium 5 into two along the perforations. In FIG. 1 and FIG. 3, the sheet cutter 50 is not shown.

In this example embodiment, as shown in FIG. 2, the sheet cutter 50 is attached to the carriage 17. The sheet cutter 50 is movable in an up-down direction with respect to the carriage 17. For example, the sheet cutter 50 may be attached to a solenoid 50A (see FIG. 4) and may be movable in the up-down direction by the solenoid 50A being turned on and off.

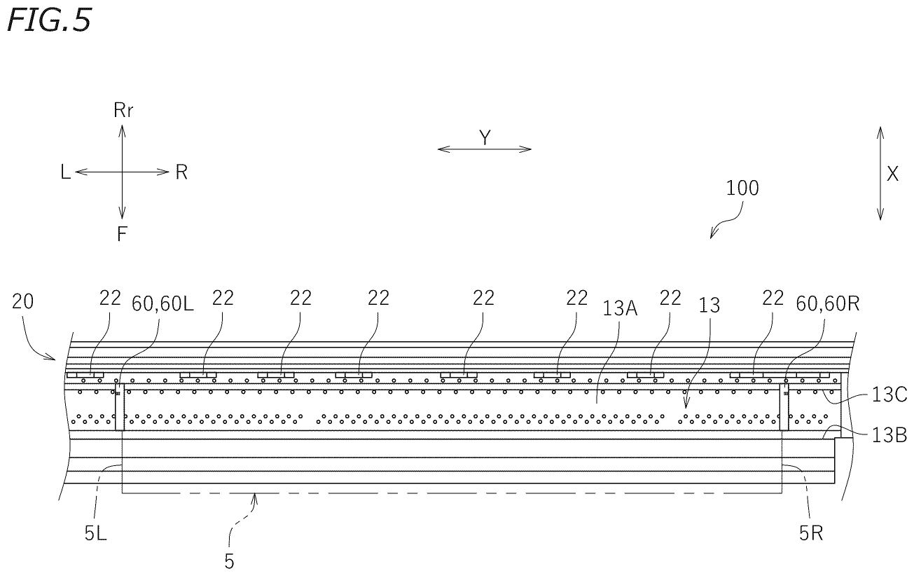

FIG. 5 is a plan view showing a configuration of the support plane 13A of the support table 13. In this example embodiment, as shown in FIG. 5, a cutter groove 13B extending in the main scanning direction Y is formed in the support plane 13A of the support table 13. As shown in FIG. 2, the sheet cutter 50 is located at a position overlapping the cutter groove 13B in the sub scanning direction X as seen in a plan view. When cutting the medium 5, the sheet cutter 50 runs through the medium 5 and goes into the cutter groove 13B.

Referring to FIG. 1, the head moving mechanism 30 is to move the carriage 17, the ink heads 40 (see FIG. 2) and the sheet cutter 50 (see FIG. 2) in the main scanning direction Y with respect to the medium 5 supported by the support table 13. In this example embodiment, the head moving mechanism 30 moves the carriage 17, the ink heads 40 and the sheet cutter 50 in the main scanning direction Y. There is no specific limitation on the configuration of the head moving mechanism 30.

In this example embodiment, the head moving mechanism 30 includes left and right pulleys 31a and 31b, a belt 32, and a scan motor 33. The left pulley 31a is provided in the vicinity of a left end of the guide rail 15. The right pulley 31b is provided in the vicinity of a right end of the guide rail 15. The belt 32 is, for example, an endless belt, and is wound along the left and right pulleys 31a and 31b. The carriage 17 is attached to, and secured to, the belt 32. The right pulley 31b is connected with the scan motor 33. In this example embodiment, the scan motor 33 is driven, and as a result, the right pulley 31b is rotated and thus the belt 32 runs. This moves the carriage 17, the ink heads 40 and the sheet cutter 50 in the main scanning direction Y along the guide rail 15.

In this example embodiment, the printer 100 includes a restrictor 60. The restrictor 60 restricts the medium 5 from rising from the support plane 13A. In this example embodiment, while the medium 5 supported by the support plane 13A is being moved in the sub scanning direction X by the medium moving mechanism 20, the restrictor 60 restricts (in other words, restrains) the medium 5 from rising from the support plane 13A. In this example embodiment, the restrictor 60 restricts both of ends 5L and 5R in the main scanning direction Y of the medium 5 from rising from the support plane 13A. The restrictor 60 includes a left restrictor 60L to restrict the left end 5L of the medium 5 from rising and a right restrictor 60R to restrict the right end 5R of the medium 5 from rising. In the following, a description common to the left restrictor 60L and the right restrictor 60R will use the term “restrictor 60” when appropriate.

As shown in FIG. 5, the restrictor 60 is a plate-shaped structure and is longer in the sub scanning direction X than in the main scanning direction Y. The restrictor 60 is attachable to, and detachable from, the support plane 13A. In this example embodiment, portions of the medium 5 including the ends 5L and 5R in the main scanning direction Y are held between the restrictor 60 and the support plane 13A, so that the ends 5L and 5R of the medium 5 are made difficult to rise. The restrictor 60 presses the medium 5 toward the support plane 13A from above. In this example embodiment, the portion of the medium 5 including the left end 5L is held between the left restrictor 60L and the support plane 13A, so that the left end 5L of the medium 5 is made difficult to rise from the support plane 13A. Similarly, the portion of the medium 5 including the right end 5R is held between the right restrictor 60R and the support plane 13A, so that the right end 5R of the medium 5 is made difficult to rise from the support plane 13A.

In this example embodiment, as shown in FIG. 5, a guide groove 13C extending in the main scanning direction Y is formed in the support plane 13A. The guide groove 13C is provided, for example, upstream with respect to (to the rear of) the cutter groove 13B in the sub scanning direction X. The restrictor 60 is engageable with the guide groove 13C, and is movable along the guide groove 13C. Although not shown, the restrictor 60 includes engageable protrusions protruding downward. The engageable protrusions are in slidable engagement with the guide groove 13C. The restrictor 60 moves in the main scanning direction Y along the guide groove 13C in this manner, so that the position in the main scanning direction Y of the restrictor 60 on the support plane 13A is determined. Therefore, the positions in the main scanning direction Y of the left restrictor 60L and the right restrictor 60R on the support plane 13A are adjustable in accordance with the length in the main scanning direction Y of the medium 5.

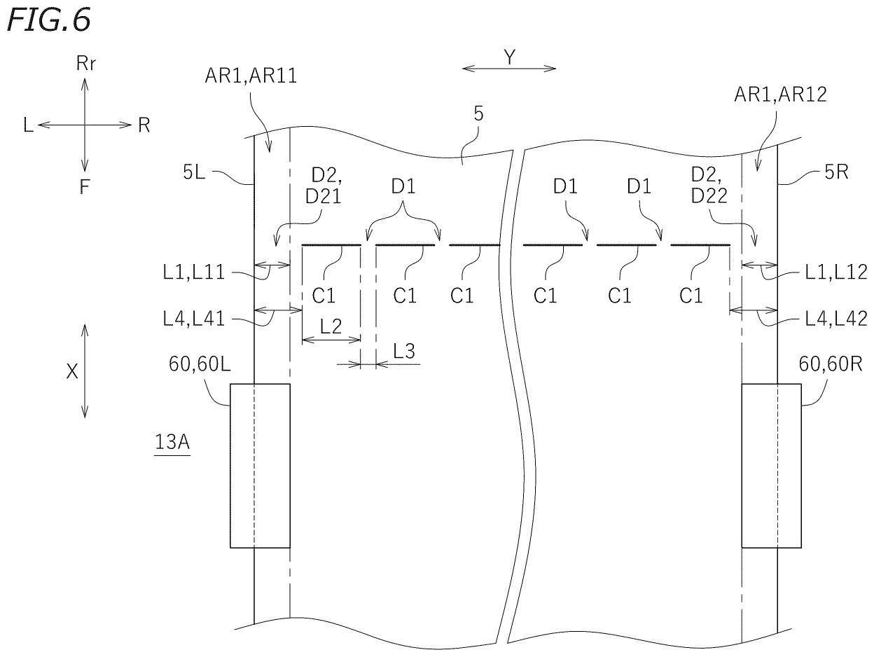

FIG. 6 is a plan view showing the restrictor 60 and cutouts C1 formed in the medium 5. In this example embodiment, while the medium 5 is being moved in the sub scanning direction X by the medium moving mechanism 20, a region of the medium 5 overlaps the restrictor 60 as shown in FIG. 6. Such a region of the medium 5, that is, a region pressed by the restrictor 60, will be referred to as an “overlapping region AR1”. The overlapping region AR1 includes at least one of the left end 5L and the right end 5R of the medium 5. In this example embodiment, the overlapping region AR1 includes a left overlapping region AR11 overlapping the left restrictor 60L while the medium 5 is being moved in the sub scanning direction X by the medium moving mechanism 20, and also includes a right overlapping region AR12 overlapping the right restrictor 60R while the medium 5 is being moved in the sub scanning direction X by the medium moving mechanism 20. In the following, a description common to the left overlapping region AR11 and the right overlapping region AR12 will use the term “overlapping region AR1” when appropriate. The overlapping region AR1 has a length L1 in the main scanning direction Y. The length L1 of the overlapping region AR1 is a length in the main scanning direction Y from the end 5L or 5R of the medium 5 to an innermost position of the overlapping region AR1 of the medium 5. For example, for the left overlapping region AR11, the “innermost position” of the overlapping region AR1 of the medium 5 is the position of a right end of the left overlapping region AR11. For the right overlapping region AR12, the “innermost position” of the overlapping region AR1 of the medium 5 is the position of a left end of the right overlapping region AR12. Regarding the overlapping region AR1, the left overlapping region A11 has a length L11 in the main scanning direction Y, and the right overlapping region A12 has a length L12 in the main scanning direction Y. In this example embodiment, the length L11 of the left overlapping region A11 and the length L12 of the right overlapping region A12 are equal to each other. Note that the length L11 and the length L12 may be different from each other.

In this example embodiment, as shown in FIG. 1, an operation panel 55 is provided at a right end of the printer main body 11 of the printer 100. The operation panel 55 includes a display screen 56 to display a state of the printer 100 and the like, operation keys 57 operable by the user, and the like.

The controller 70 is configured or programmed to perform controls on printing and the like. There is no specific limitation on the configuration of the controller 70. The controller 70 is, for example, a microcomputer. There is no specific limitation on the hardware configuration of the microcomputer. The controller 70 includes, for example, an I/F, a CPU, a ROM, and a RAM. The controller 70 is provided inside the printer main body 11. Note that the controller 70 may be realized by a computer or the like provided outer to the printer main body 11. In this case, the controller 70 is communicably connected with a control board (not shown) of the printer 100 in a wired or wireless manner.

In this example embodiment, as shown in FIG. 4, the controller 70 is communicably connected with the medium moving mechanism 20 (more specifically, the feed motor 23), the head moving mechanism 30 (more specifically, the scan motor 33), the ink heads 40, the solenoid 50A included in the sheet cutter 50, and the operation panel 55. The controller 70 is configured or programmed to control the medium moving mechanism 20, the head moving mechanism 30, the ink heads 40, the solenoid 50A and the operation panel 55.

After, for example, the printing is performed on the medium 5 with the ink discharged from the ink heads 40, sheet cutting is performed on the medium 5 by the sheet cutter 50 in order to cut away a portion of the medium 5 where the printing has been performed. In this example embodiment, the controller 70 includes a storage 71 and a cutout formation controller 73 in order to perform the sheet cutting. The storage 71 stores, in advance, information necessary to perform the sheet cutting. The cutout formation controller 73 may be realized by one or a plurality of processors or may be realized by a circuit.

In this example embodiment, as shown in FIG. 6, the cutout formation controller 73 shown in FIG. 4 forms a perforation portion extending in the main scanning direction Y in the medium 5 when the sheet cutting is to be performed on the medium 5. In this example embodiment, the perforation portion includes cutouts C1 and cutout margins D1. The cutouts C1 linearly extend in the main scanning direction Y. The plurality of cutouts C1 are formed in the medium 5 so as to be aligned in the main scanning direction Y. The cutout margins D1 are each provided between two cutouts C1 adjacent to each other in the main scanning direction Y. No cutout C1 is formed in the cutout margins D1. In this example embodiment, the cutouts C1 and the cutout margins D1 are alternately formed in the main scanning direction Y in the medium 5, so that the perforation portion is formed. In this example embodiment, the cutout formation controller 73 performs control such that the plurality of cutouts C1, each extending in the main scanning direction Y and aligned in the main scanning direction Y, are formed in the medium 5 by the sheet cutter 50.

In this example embodiment, the plurality of cutouts C1 all have an equal length L2. Alternatively, the plurality of cutouts C1 may have different lengths from each other. Similarly, the plurality of cutout margins D1 all have an equal length L3. Alternatively, the plurality of cutout margins D1 may have different lengths from each other. In this example embodiment, the length L2 of each cutout C1 and the length L3 of each cutout margin D1 are each a length in the main scanning direction Y. In this example embodiment, the length L2 of each cutout C1 is longer than the length L3 of each cutout margin D1. For example, the length L2 of each cutout C1 is at least 1.5 times, preferably at least twice, especially preferably at least 3 times, and, for example, at least 5 times, the length L3 of each cutout margin D1.

When the plurality of cutouts C1 are to be formed in the medium 5 to form the perforation portion, if a cutout C1 is formed at the left end 5L or the right end 5R of the medium 5, the portion of the medium 5 including the end 5L or 5R, where the cutout C1 is formed, may easily rise. If the medium 5 is moved in the sub scanning direction X by the medium moving mechanism 20 to enter a gap between the restrictor 60 and the support plane 13A in the state where the portion of the medium including the end 5L or 5R, where the cutout C1 is formed, is risen in this manner, the risen portion of the medium 5 may undesirably be stuck with the restrictor 60 or ride on the restrictor 60. If the medium 5 is further moved in the sub scanning direction X in the state where the risen portion of the medium 5 is stuck with the restrictor 60 or rides on the restrictor 60, the risen portion of the medium 5 may undesirably contact the ink heads 40. This may undesirably destroy the medium 5.

In this example embodiment, as shown in FIG. 6, the cutout formation controller 73 shown in FIG. 4 performs control such that the plurality of cutouts C1 are formed in the medium 5, with no cutout C1 being formed at either end of the medium 5 in the main scanning direction Y, that is, with no cutout C1 being formed at the left end 5L or the right end 5R.

In this example embodiment, an end margin D2 is provided from the ends 5L and 5R in the main scanning direction Y of the medium 5 to the cutouts C1 formed at positions closest to the ends 5L and 5R. The end margin D2 includes a left end margin D21 provided from the left end 5L of the medium 5 to the leftmost cutout C1, and a right end margin D22 provided from the right end 5R of the medium 5 to the rightmost cutout C1. In the following, a description common to the left end margin D21 and the right end margin D22 will use the term “end margin D2” when appropriate. The left end margin D21 includes the left end 5L of the medium 5. The right end margin D22 includes the right end 5R of the medium 5. In this example embodiment, no cutout C1 is formed in the end margin D2 (more specifically, no cutout C1 is formed in the left end margin D21 or the right end margin D22).

In this example embodiment, as shown in FIG. 6, the end margin D2 has a length L4 in the main scanning direction Y. The length L4 is longer than the length L1 in the main scanning direction Y of the overlapping region AR1 of the medium 5. In this example embodiment, the left end margin D21 has a length L41 in the main scanning direction Y, which is longer than the length L11 of the left overlapping region AR11 of the medium 5. The right end margin D22 has a length L42 in the main scanning direction Y, which is longer than the length L12 of the right overlapping region AR12 of the medium 5. That is, when the medium 5 enters a gap between the restrictor 60 and the support plane 13A, the cutouts C1 do not enter the gap between the restrictor 60 and the support plane 13A, but the end margin D2 enters the gap. In this example embodiment, the length L4 of the end margin D2 (in other words, each of the length L41 of the left end margin D21 and the length L42 of the right end margin D22) is shorter than the length L2 of each cutout C1. Note that the length L4 of the end margin D2 may be as long as, or longer than, the length L2 of each cutout C1. In this example embodiment, the length L4 of the end margin D2 (in other words, each of the length L41 of the left end margin D21 and the length L42 of the right end margin D22) is longer than the length L3 of each cutout margin D1. Note that the length L4 of the end margin D2 may be as long as, or shorter than, the length L3 of each cutout margin D1.

In this example embodiment, as shown in FIG. 6, the cutout formation controller 73 shown in FIG. 4 performs control such that the cutouts C1 aligned in the main scanning direction Y are formed in the medium 5 supported by the support plane 13A. The cutout formation controller 73 controls the sheet cutter 50 such that the plurality of cutouts C1 aligned in the main scanning direction Y are formed in the medium 5, with no cutout C1 being formed at the end 5L or 5R in the main scanning direction Y of the medium 5. In this example embodiment, the cutout formation controller 73 forms the plurality of cutouts C1 in the medium 5, with the end margin D2 being provided at the ends 5L and 5R of the medium 5. In other words, the cutout formation controller 73 forms the plurality of cutouts C1 in a portion of the medium 5 where the cutouts C1 do not enter a gap between the restrictor 60 and the support plane 13A while the medium 5 supported by the support plane 13A is being moved in the sub scanning direction X by the medium moving mechanism 20.

In this example embodiment, the cutout formation controller 73 controls the medium moving mechanism 20 to move the medium 5 in the sub scanning direction X such that a portion of the medium 5 to be subjected to sheet cutting is located right below the sheet cutter 50 as shown in FIG. 2. Next, the cutout formation controller 73 controls the solenoid 50A (see FIG. 4) to move the sheet cutter 50 downward such that the sheet cutter 50 goes into the cutter groove 13B formed in the support plane 13A. At this point, the sheet cutter 50 is caused to run through the medium 5 at a position where a cutouts C1 is to be formed in the medium 5. At this point, the sheet cutter 50 is located at such a position as not to run through the medium 5 in the end margin D2 of the medium 5. In this state, the cutout formation controller 73 controls the head moving mechanism 30 such that the sheet cutter 50, together with the carriage 17, moves in the main scanning direction Y by the length L2 of the cutout C1. As a result, a cutout C1 having the length L2 is formed in a portion of the medium 5 excluding the end margin D2.

Then, the cutout formation controller 73 moves the sheet cutter 50 until the sheet cutter 50 is located above the cutter groove 13B, that is, until the sheet cutter 50 is located at such a position as not to run through the medium 5. After this, the cutout formation controller 73 moves the sheet cutter 50, together with the carriage 17, in the main scanning direction Y by the length L3 of the cutout margin D1. Then, another cutout C1 is formed in the medium 5. In this manner, the sheet cutter 50 is moved in the main scanning direction Y together with the carriage 17 while being moved in the up-down direction appropriately, so that the plurality of cutouts C1 are formed in the medium 5 to form the perforation portion.

In this example embodiment, after the plurality of cutouts C1 are formed in the medium 5, that is, after the perforation portion is formed as the sheet cutting as shown in FIG. 6, the user manually cuts the cutout margins D1 so as to connect the plurality of cutouts C1. The end margin D2 of the medium 5 is manually cut in the main scanning direction Y. As a result, the medium 5 is divided into two along the perforation portion formed of the plurality of cutouts C1.

As described above, in this example embodiment, as shown in FIG. 2, the printer 100 includes the support table 13, the medium moving mechanism 20, the sheet cutter 50 as an example of cutter, and the controller 70 (see FIG. 1). The support table 13 includes the support plane 13A to support the medium 5. The medium moving mechanism 20 moves the medium 5, supported by the support plane 13A, in the sub scanning direction X. The sheet cutter 50 cuts the medium 5 supported by the support plane 13A. As shown in FIG. 4, the controller 70 is configured or programmed to include the cutout formation controller 73. As shown in FIG. 6, the cutout formation controller 73 is configured or programmed to perform control such that the plurality of cutouts C1 each extending in the main scanning direction Y and aligned in the main scanning direction Y are formed in the medium 5 supported by the support plane 13A, with no cut output C1 being formed at the end 5L or 5R in the main scanning direction Y of the medium 5. In this manner, in this example embodiment, the plurality of cutouts C1 aligned in the main scanning direction Y are formed in the medium 5 while no cutout C1 is formed at the end 5L or 5R in the main scanning direction Y of the medium 5. No cutout C1 is formed at the end 5L or 5R of the medium 5, and therefore, the ends 5L and 5R of the medium 5 are difficult to rise.

In this example embodiment, as shown in FIG. 5, the printer 100 includes the restrictor 60. The restrictor 60 is provided on the support plane 13A, and holds the ends 5L and 5R in the main scanning direction Y of the medium 5 supported by the support plane 13A, together with the support plane 13A. As shown in FIG. 6, the cutout formation controller 73 shown in FIG. 4 forms the cutouts C1 in a portion of the medium 5 that does not enter a gap between the restrictor 60 and the support plane 13A while the medium 5 supported by the support plane 13A is being moved in the sub scanning direction X. This prevents the portion including the cutouts C1 formed in the medium 5 from entering a gap between the restrictor 60 and the support plane 13A. Therefore, while the medium 5 is being moved in the sub scanning direction X, the portion including the cutouts C1 formed in the medium 5 is not easily stuck with the restrictor 60 or does not easily ride on the restrictor 60. This allows the medium 5 supported by the support plane 13A to be moved in the sub scanning direction X smoothly.

In this example embodiment, as shown in FIG. 6, the end margin D2 is provided in a portion of the medium 5 from the ends 5L and 5R of the medium 5 to the cutouts C1 closest to the ends 5L and 5R of the medium 5. The region of the medium 5, supported by the support plane 13A, that overlaps the restrictor 60 is referred to as the “overlapping region AR1”. The length L4 in the main scanning direction Y of the end margin D2 is longer than the length L1 in the main scanning direction Y from the end 5L or 5R of the medium 5 to the innermost position of the overlapping region AR1 of the medium 5 (in this example embodiment, the innermost position in the main scanning direction Y). With this configuration, while the medium 5 supported by the support plane 13A is being moved in the sub scanning direction X, the end margin D2 with no cutout C1 is allowed to enter a gap between the restrictor 60 and the support plane 13A. Therefore, while the medium 5 is being moved in the sub scanning direction X, the portion including the cutouts C1 formed in the medium 5 is not easily stuck with the restrictor 60 or does not easily ride on the restrictor 60.

In this example embodiment, as shown in FIG. 6, the cutout margins D1 are provided between the cutouts C1 adjacent to each other in the main scanning direction Y. The length L4 in the main scanning direction Y of the end margin D2 is longer than the length L3 in the main scanning direction Y of each cutout margin D1. This makes the length L4 of the end margin D2 relatively long. Therefore, while the medium 5 is being moved in the sub scanning direction X, the portion including the cutouts C1 formed in the medium 5 is not easily stuck with the restrictor 60 or does not easily ride on the restrictor 60.

In this example embodiment, the length L4 in the main scanning direction Y of the end margin D2 is shorter than the length L2 in the main scanning direction Y of each cutout C1. If, for example, the length L4 of the end margin D2 is too long, it is difficult for the user to manually cut the end margin D2 of the medium 5. However, in this example embodiment, the length L4 of the end margin D2 is shorter than the length L2 of each cutout C1. Therefore, the user may cut the end margin D2 of the medium 5 relatively easily.

In this example embodiment, as shown in FIG. 6, the length L2 in the main scanning direction Y of each cutout C1 is longer than the length L3 in the main scanning direction Y of each cutout margin D1. This makes the distance between the cutouts C1 adjacent to each other in the main scanning direction Y short. Therefore, the user may easily cut the medium 5 along the plurality of cutouts C1.

Now, a printer 100A according to example embodiment 2 will be described. The printer 100A basically has the same configuration as that of the printer 100 according to example embodiment 1, but is partially different therefrom. Hereinafter, elements that are the same as those of the printer 100 according to example embodiment 1 will bear the same reference signs, and descriptions thereof will be omitted when appropriate.

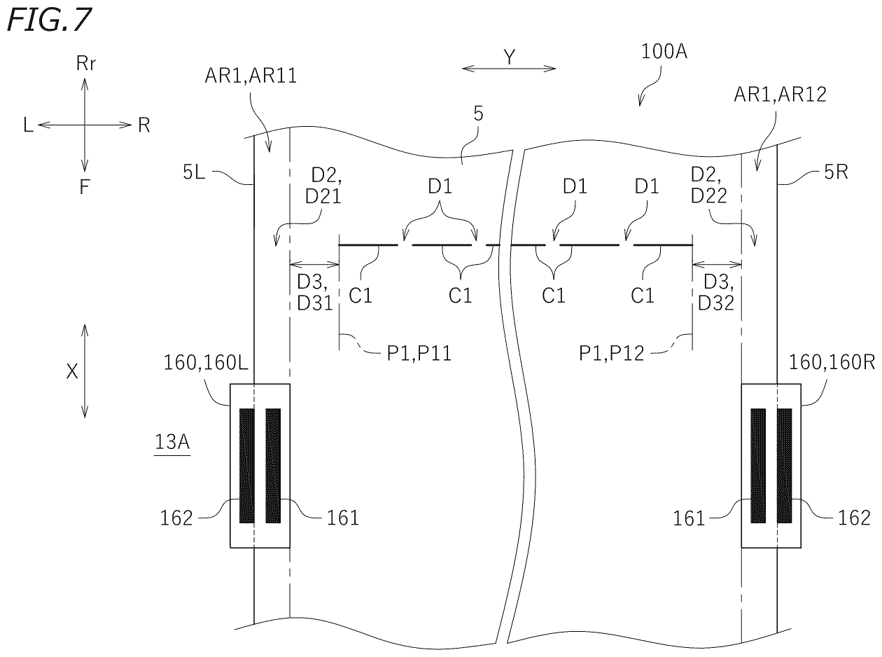

FIG. 7 is a plan view showing the cutouts C1 formed in the medium 5 in the case where a restrictor 160 is provided on the support plane 13A in this example embodiment. As shown in FIG. 7, in this example embodiment, the printer 100A includes the restrictor 160 restricting the ends 5L and 5R of the medium 5 from rising from the support plane 13A. In this example embodiment, the restrictor 160 includes a left restrictor 160L restricting the left end 5L of the medium 5 from rising and a right restrictor 160R restricting the right end 5R of the medium 5 from rising.

The restrictor 160 is rectangular or substantially rectangular like the restrictor 60 in example embodiment 1, for example. In this example embodiment, the restrictor 160 includes detection regions 161 and 162. In each of the restrictor 160L and the restrictor 160R, the detection regions 161 and 162 are aligned in the main scanning direction Y. The detection regions 161 and 162 are, for example, rectangular, but there is no specific limitation on the shape thereof. In this example embodiment, the detection regions 161 and 162 have a color different from that of a portion of the restrictor 160 other than the detection regions 161 and 162. In this example embodiment, the detection regions 161 and 162 are black. The portion of the restrictor 160 other than the detection regions 161 and 162 is white.

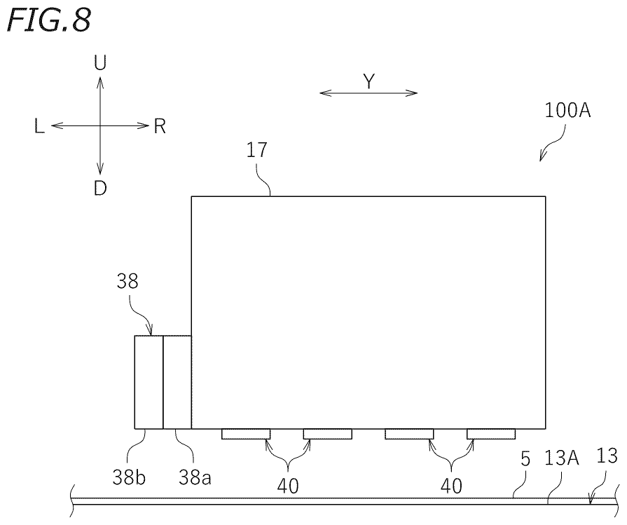

FIG. 8 is a front view showing the carriage 17 and a sensor 38. In this example embodiment, as shown in FIG. 8, the printer 100A includes the sensor 38. The sensor 38 detects whether or not the restrictor 160 is provided on the support plane 13A. In this example embodiment, in the case where the restrictor 160 is provided on the support plane 13A, the sensor 38 detects the position of the restrictor 160 with respect to the support plane 13A (more specifically, the position in the main scanning direction Y of the restrictor 160). The sensor 38 is provided on the carriage 17. In this example embodiment, the sensor 38 is provided to the left of the carriage 17. There is no specific limitation on the position of the sensor 38 with respect to the carriage 17.

There is no specific limitation on the type of the sensor 38. In this example embodiment, the sensor 38 is an optical sensor. In this example embodiment, the sensor 38 includes, for example, a light emitting portion 38a emitting light and a light receiving portion 38b receiving the light reflected by an object. In this example embodiment, the sensor 38 moves in the main scanning direction Y along with the movement of the carriage 17 in the main scanning direction Y. While the sensor 38 is being moved above the restrictor 160 in the main scanning direction Y, the light emitting portion 38a emits light toward the restrictor 160 (see FIG. 7). This light is reflected by the restrictor 160 and is received by the light receiving portion 38b. In this example embodiment, the light reflected by the detection regions 161 and 162 of the restrictor 160 and the light reflected by the portion of the restrictor 160 other than the detection regions 161 and 162 have different wavelengths from each other when being received by the light receiving portion 38b. In the case where a detected pattern using this difference in the wavelength matches a predefined detection pattern showing the existence of the restrictor 160, the sensor 38 detects that the restrictor 160 is provided on the support plane 13A. By contrast, in the case where the detected pattern does not match the detection pattern showing the existence of the restrictor 160, the sensor 38 detects that the restrictor 160 is not provided on the support plane 13A.

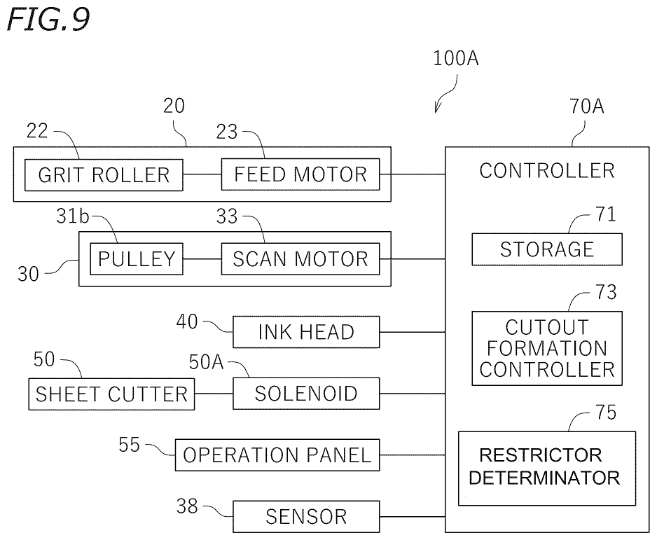

FIG. 9 is a block diagram of the printer 100A according to this example embodiment. In this example embodiment, as shown in FIG. 9, the printer 100A includes a controller 70A. The controller 70A is communicably connected with the sensor 38. The controller 70A includes the storage 71 and the cutout formation controller 73. The controller 70A further includes a restrictor determinator 75.

The restrictor determinator 75 determines whether or not the restrictor 160 is provided on the support plane 13A. In this example embodiment, the restrictor determinator 75 determines whether or not the restrictor 160 is provided on the support plane 13A, based on the detected pattern detected by the sensor 38. The restrictor determinator 75 also detects the position in the main scanning direction Y of the restrictor 160 with respect to the support plane 13A, based on the position in the main scanning direction Y of the sensor 38 when the detected pattern is detected.

In this example embodiment, the restrictor determinator 75 controls the head moving mechanism 30 (see FIG. 1) such that the sensor 38 moves in the main scanning direction Y above a portion, of the support plane 13A, where the restrictor 160 is estimated to be provided (e.g., a portion, of the support plane 13A, that is in the vicinity of the guide groove 13B). While the sensor 38 is being moved in the main scanning direction Y, the restrictor determinator 75 causes the light emitting portion 38a of the sensor 38 to emit light and causes the light receiving portion 38b to receive the reflected light. The restrictor determinator 75 detects a detected pattern based on, for example, the wavelength of the light received by the light receiving portion 38b. Based on whether or not the detected pattern detected in this manner matches the detection pattern of the restrictor 160, the restrictor determinator 75 determines whether or not the restrictor 160 is provided.

In this example embodiment, upon receipt of the determination result made by the restrictor determinator 75, the cutout formation controller 73 determines the position, in the main scanning direction Y, at which the formation of a cutout C1 is to be started. In other words, the cutout formation controller 73 determines the position at which the formation of the cutout C1 is to be started, based on whether or not the restrictor 160 is provided on the support plane 13A.

In the case where as shown in FIG. 7, the restrictor 160 is provided on the support plane 13A, the cutout formation controller 73 performs control such that the cutout C1 is formed from a first separation position P1, which is inward relative to an inner end in the main scanning direction Y of the restrictor 160 and is spaced away from the inner end by a predetermined first distance D3 in the main scanning direction Y. In this example embodiment, for the left restrictor 160L, the “inner end in the main scanning direction Y of the restrictor 160” is a right end of the left restrictor 160L. For the right restrictor 160R, the “inner end in the main scanning direction Y of the restrictor 160” is a left end of the right restrictor 160R. In this example embodiment, the leftmost cutout C1 extends rightward from a first left separation position P11, which is to the right of the right end of the left restrictor 160L and is spaced away from the right end by a first left distance D31. By contrast, the rightmost cutout C1 extends leftward from a first right separation position P12, which is to the left of the left end of the right restrictor 160R and is spaced away from the left end by a first right distance D32.

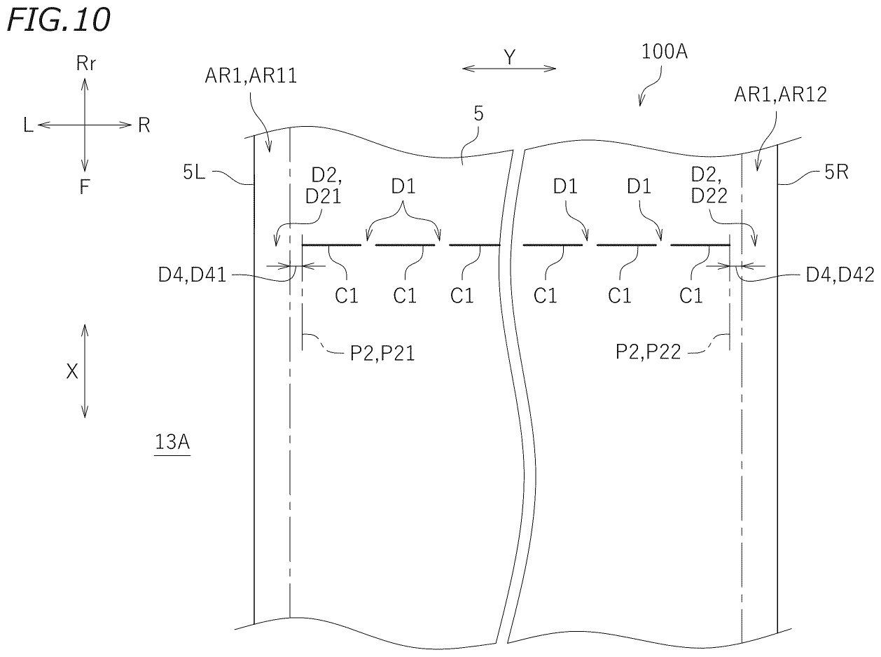

FIG. 10 is a plan view showing the cutouts C1 formed in the medium 5 in the case where the restrictor 160 is not provided on the support plane 13A. As shown in FIG. 10, in the case where the restrictor 160 is not provided on the support plane 13A, the cutout formation controller 73 performs control such that a cutout C1 is formed from a second separation position P2, which is inward relative to an inner end in the main scanning direction Y of the overlapping region AR1 of the medium 5 and is spaced away from the inner end by a predetermined second distance D4 in the main scanning direction Y. In this example embodiment, for the left overlapping region AR11, the “inner end in the main scanning direction Y of the overlapping region AR1” is a right end of the left overlapping region AR11. For the right overlapping region AR12, the “inner end in the main scanning direction Y of the overlapping region AR1” is a left end of the right overlapping region AR12. In this example embodiment, the leftmost cutout C1 extends rightward from a second left separation position P21, which is to the right of the right end of the left overlapping region AR11 and is spaced away from the right end by a second left distance D41. By contrast, the rightmost cutout C1 extends leftward from a second right separation position P22, which is to the left of the left end of the right overlapping region AR12 and is spaced away from the left end by a second right distance D42.

In this example embodiment, as shown in FIG. 7 and FIG. 10, the second distance D4 is shorter than the first distance D3. Therefore, the second separation position P2 is located outer, in the main scanning direction Y, to the first separation position P1. In this example embodiment, the second left distance D41 is shorter than the first left distance D31, and the second right distance D42 is shorter than the first right distance D32. The second left separation position P21 is located to the left of the first left separation position P11, and the second right separation position P22 is located to the right of the first right separation position P12. In this example embodiment, for example, the first distance D3 (in other words, each of the first left distance D31 and the first right distance D32) is 10 mm, and the second distance D4 (in other words, each of the second left distance D41 and the second right distance D42) is 1 mm. As shown in FIG. 7, in this example embodiment, the distance in the main scanning direction Y from the left end 5L of the medium 5 to the first left separation position P11 (also, the distance in the main scanning direction Y from the right end 5R of the medium 5 to the first right separation position P12) is 19 mm, for example. As shown in FIG. 10, the distance in the main scanning direction Y from the left end 5L of the medium 5 to the second left separation position P21 (also, the distance in the main scanning direction Y from the right end 5R of the medium 5 to the second right separation position P22) is 10 mm, for example.

In this example embodiment, in the case where as shown in FIG. 7, the restrictor 160 is provided on the support plane 13A, the cutouts C1 are formed in a portion of the medium 5 that does not overlap the restrictor 160. By contrast, in the case where the restrictor 160 is not provided on the support plane 13A as shown in FIG. 10, the cutouts C1 are formed in a portion of the medium 5 that is spaced away from the overlapping region AR1 of the medium 5. Therefore, even when the restrictor 160 is provided on the support plane 13A after the cutouts C1 are formed in the medium 5, the cutouts C1 do not overlap the restrictor 160. With such a configuration, while the medium 5 is being moved in the sub scanning direction X, the portion including the cutouts C1 formed in the medium 5 is not easily stuck with the restrictor 160 or does not easily ride on the restrictor 160.

In each of the above-described example embodiments, the cutouts C1 are formed by the sheet cutter 50 cutting the medium 5 in the main scanning direction Y. The cutter is not limited to the sheet cutter 50. The cutter may be a cutter that cuts the medium 5 based on so-called cut data, or a cutter that cuts the medium 5 along a curved line or that cuts the medium 5 along a straight line in the sub scanning direction X. Such a cutter may form the plurality of cutouts C1 (i.e., the perforation portion) in the medium 5 as the sheet cutting.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer, comprising:
a support table including a support plane to support a medium;
a medium moving mechanism to move the medium, supported by the support plane, in a first direction;
a restrictor provided on the support plane to hold, together with the support plane, an end in a second direction of the medium supported by the support plane, the second direction crossing the first direction;
a cutter to cut the medium supported by the support plane; and
a controller configured or programmed to include a cutout formation controller configured or programmed to perform control such that a plurality of cutouts extending in the second direction are formed in the medium supported by the support plane;
an end margin is provided in a portion of the medium between the end of the medium and one of the plurality of cutouts that is closest to the end of the medium; and
where a region of the medium supported by the support plane that overlaps the restrictor is an overlapping region, the end margin has a length in the second direction that is longer than a length in the second direction from the end of the medium to an innermost position of the overlapping region of the medium.

2. The printer according to claim 1, wherein
the plurality of the cutouts aligned in the second direction are formed in the medium supported by the support plane;
a cutout margin is provided between the cutouts adjacent to each other in the second direction; and
the length in the second direction of the end margin is longer than a length in the second direction of the cutout margin.

3. The printer according to claim 2, wherein a length in the second direction of each of the cutouts is longer than the length in the second direction of the cutout margin.

4. The printer according to claim 1, wherein the length in the second direction of the end margin is shorter than a length in the second direction of each of the cutouts.

5. A printer, comprising:
a support table including a support plane to support a medium;
a medium moving mechanism to move the medium, supported by the support plane, in a first direction;
a restrictor provided on the support plane to hold, together with the support plane, an end in a second direction of the medium supported by the support plane, the second direction crossing the first direction;
a cutter to cut the medium supported by the support plane;
a sensor to detect whether or not the restrictor is provided on the support plane; and
a controller configured or programmed to include a cutout formation controller configured or programmed to perform control such that a cutout extending in the second direction is formed in the medium supported by the support plane; and
a restrictor determinator to determine whether or not the restrictor is provided on the support plane; and
where a region of the medium supported by the support plane that overlaps the restrictor is an overlapping region;
when the restrictor determinator determines that the restrictor is provided on the support plane, the cutout formation controller is configured or programmed to perform control such that the cutout is formed from a first separation position that is inward, in the second direction, relative to an inner end in the second direction of the restrictor and is spaced away from the inner end by a predetermined first distance; and
when the restrictor determinator determines that the restrictor is not provided on the support plane, the cutout formation controller is configured or programmed to perform control such that the cutout is formed from a second separation position that is inward, in the second direction, relative to an inner end in the second direction of the overlapping region of the medium and is spaced away from the inner end by a predetermined second distance shorter than the first distance.
